(19) United States
(12) Patent Application Publication
(10) Pub. No.: US 2023/0025375 A1
(43) Pub. Date: Jan. 26, 2023

(54) BATTERY HAVING AN ENCAPSULATION SYSTEM THAT IS REINFORCED AT THE CONTACT MEMBERS

(71) Applicant: I-TEN, Dardilly (FR)

(72) Inventors: Fabien GABEN, Dardilly (FR); Ian CAYREFOURCQ, Villefontaine (FR); David GRUET, Thurins (FR); Claire SORRIANO, Lyon (FR)

(21) Appl. No.: 17/788,359

(22) PCT Filed: Dec. 23, 2020
(86) PCT No.: PCT/IB2020/062397

§ 371 Date: Jun. 23, 2022

(30) Foreign Application Priority Data
Dec. 24, 2019 (FR) 1915540
Dec. 24, 2019 (FR) 1915566

(51) Int. Cl. H01M 50/124; H01M 10/0525; H01M 10/0585; H01M 50/121; H01M 50/14; H01M 50/534; H01M 50/562; H01M 50/552; H01M 50/133; H01M 50/586; H01M 50/59

(52) U.S. Cl. CPC H01M 50/124; H01M 10/0525; H01M 10/0585; H01M 50/121; H01M 50/14; H01M 50/534; H01M 50/562; H01M 50/552; H01M 50/133; H01M 50/586; H01M 50/59

(57) ABSTRACT

Thin-film batteries having a novel encapsulation system.

### CROSS-REFERENCE TO RELATED APPLICATIONS

The present application is a National Stage Application of PCT International Application No. PCT/IB2020/062397 (filed on Dec. 23, 2020), under 35 U.S.C. § 371, which claims priority to French Patent Application No. 1915540 (filed on Dec. 24, 2019), and French Patent Application No. 1915566 (filed on Dec. 24, 2019), which are each hereby incorporated by reference in their complete respective entireties.

### TECHNICAL FIELD

The present invention relates to batteries, in particular to thin-film batteries, and more particularly to the encapsulation systems protecting them. It proposes a novel encapsulation system that more effectively protects the zones of the battery near the contact members. The invention more particularly relates to the field of lithium-ion batteries, which can be encapsulated in this way. The invention further relates to a novel method for manufacturing thin-film batteries, having a novel architecture and encapsulation that gives them a particularly low self-discharge rate and a longer life.

### BACKGROUND

Some types of batteries, an in particular some types of thin-film batteries, need to be encapsulated in order to have a long life because oxygen and moisture cause degradation thereto. In particular, lithium-ion batteries are very sensitive to moisture. The market demands a product life of more than 10 years; an encapsulation must thus be provided to guarantee this life.

Thin-film lithium-ion batteries are multi-layer stacks comprising electrode and electrolyte layers typically between about one μm and about ten μm thick. They can comprise a stack of a plurality of unit cells. These batteries are seen to be sensitive to self-discharge. Depending on the positioning of the electrodes, in particular the proximity of the edges of the electrodes for multi-layer batteries and the cleanness of the cuts, a leakage current can appear at the ends, i.e. a creeping short-circuit which reduces battery performance. This phenomenon is exacerbated if the electrolyte film is very thin.

These solid-state thin-film lithium-ion batteries usually use anodes having a lithium metal layer. The volume of the anode materials is seen to vary significantly during charge and discharge cycles of the battery. More specifically, during a charge and discharge cycle, part of the lithium metal is transformed into lithium ions, which are inserted into the structure of the cathode materials, which is accompanied by a reduction in the volume of the anode. This cyclic variation in volume can deteriorate the mechanical and electrical contacts between the electrode and electrolyte layers. This reduces battery performance during its life.

The cyclic variation in the volume of the anode materials also induces a cyclic variation in the volume of the battery cells. It thus generates cyclic stresses on the encapsulation system, which are liable to initiate cracks causing a loss of imperviousness (or even a loss of integrity) of the encapsulation system. This phenomenon is yet another cause of reduced battery performance during the life thereof.

More specifically, the active materials of lithium-ion batteries are very sensitive to air and in particular to moisture. Mobile lithium ions react spontaneously with traces of water to form LiOH, resulting in calendar ageing of the batteries. All lithium ion-conductive electrolytes and insertion materials are non-reactive to moisture. By way of example, Li₄Ti₅O₁₂ does not deteriorate when in contact with the atmosphere or traces of water. By contrast, as soon as it is filled with lithium in the form Li₄₊ₓTi₅O₁₂, where x>0, the inserted lithium surplus (x) is sensitive to the atmosphere and reacts spontaneously with traces of water to form LiOH. The reacted lithium is thus no longer available for storing electricity, resulting in a loss of capacity of the battery.

To prevent exposure of the active materials of the lithium-ion battery to air and water and to prevent this type of ageing, it must be protected with an encapsulation system. Numerous encapsulation systems for thin-film batteries are described in the literature.

The U.S. Patent Publication No. 2002/0071989 describes an encapsulation system for a solid-state thin-film battery comprising a stack of a first layer of a dielectric material selected from among alumina (Al₂O₃), silica (SiO₂), silicon nitride (Si₃N₄), silicon carbide (SiC), tantalum oxide (Ta₂O₅) and amorphous carbon, a second layer of a dielectric material and an impervious sealing layer disposed on the second layer and covering the entire battery.

U.S. Pat. No. 5,561,004 describes a plurality of systems for protecting a thin-film lithium-ion battery. A first proposed system comprises a parylene layer covered with an aluminium film deposited on the active components of the battery. However, this system for protecting against air and water vapour diffusion is only effective for about a month. A second proposed system comprises alternating layers of parylene (500 nm thick) and metal (about 50 nm thick). The document states that it is preferable to coat these batteries again with an ultraviolet-cured (UV-cured) epoxy coating to reduce the speed at which the battery is degraded by atmospheric elements.

The Applicant has also proposed, in the International Patent Publication WO 2019/215410, various examples of layers, intended to form anode and cathode contact members respectively. In the first example, a first thin layer is deposited by ALD and is in particular metallic. Moreover, a second layer of silver-filled epoxy resin is provided. In the second example, the first layer is a graphite-filled material, whereas the second layer comprises copper metal obtained from a nanoparticle-filled ink.

According to the prior art, most lithium-ion batteries are encapsulated in metallised polymer foils (called “pouches”) enclosed around the battery cell and heat-sealed at the connector tabs. These packagings are relatively flexible and the positive and negative connections of the battery are thus embedded in the heat-sealed polymer that was used to seal the packaging around the battery. However, this weld between the polymer foils is not totally impervious to atmospheric gases, since the polymers used to heat-seal the battery are relatively permeable to atmospheric gases. Permeability is seen to increase with the temperature, which accelerates ageing.

However, the surface area of these welds exposed to the atmosphere remains very small, and the rest of the packaging is formed by aluminium foils sandwiched between these polymer foils. In general, two aluminium foils are combined to minimise the effects of the presence of holes, which constitute defects in each of these aluminium foils. The probability of two defects on each of the strips being aligned is greatly reduced.

These packaging technologies guarantee a calendar life of about 10 to 15 years for a 10 Ah battery with a 10×20 cm2 surface area, under normal conditions of use. If the battery is exposed to a high temperature, this life can be reduced to less than 5 years, which is insufficient for many applications. Similar technologies can be used for other electronic components, such as capacitors and active components.

As a result, there is a need for systems and methods for encapsulating thin-film batteries and other electronic components that protect the component from air, moisture and the effects of temperature. The encapsulation system must be impervious and hermetically-sealed, it must completely enclose and cover the component or battery, and it must also allow the edges of electrodes of opposite polarities to be galvanically separated in order to prevent any creeping short-circuit.

### SUMMARY

One purpose of the present invention is to overcome, at least in part, the aforementioned drawbacks of the prior art.

Another purpose of the present invention is to propose lithium-ion batteries with a very long life and a low self-discharge rate.

The encapsulation system according to the invention is advantageously of the stiff type. The battery cells are stiff and dimensionally stable due to the initial choice of materials. As a result, the encapsulation system obtained according to the invention is effective.

The invention provides for producing an encapsulation system that can be and that is advantageously deposited in a vacuum.

Batteries according to the invention do not contain polymers; they can, however, contain ionic liquids. More specifically, they are either solid-state or of the “quasi-solid state” type, in which case they include a nano-confined ionic liquid-based electrolyte. From an electrochemical point of view, this nano-confined liquid electrolyte behaves like a liquid, insofar as it provides good mobility to the cations conducted thereby. From a structural point of view, this nano-confined liquid electrolyte does not behave like a liquid, since it remains nano-confined and can no longer escape its prison even when treated in a vacuum and/or at a high temperature. Batteries according to the invention, which contain a nano-confined ionic liquid-based electrolyte, can thus undergo vacuum and/or vacuum and high-temperature treatments for the encapsulation thereof. In order to carry out impregnation before encapsulation, the edges of the layers can be exposed by cutting; after impregnation, these edges are closed off by making the electrical contact. The method according to the invention is also well suited for covering mesoporous surfaces.

At least one of the above purposes is achieved through at least one of the objects according to the invention as described hereinbelow. The objects proposed by the present invention relate to a battery, the method of manufacture thereof and an energy-consuming device according to the accompanying claims.

The present invention provides as a first object a battery comprising:

at least one unit cell, said unit cell successively comprising an anode current-collecting substrate, an anode layer, a layer of an electrolyte material or of a separator impregnated with an electrolyte, a cathode layer, and a cathode current-collecting substrate;

an encapsulation system covering at least part of the outer periphery of said unit cell, the encapsulation system comprising: at least one first cover layer (2), preferably chosen from among parylene, parylene F, polyimide, epoxy resins, acrylates, fluoropolymers, silicone, polyamide, sol-gel silica, organic silica and/or a mixture thereof, deposited on the battery, and at least one second cover layer (3) made of an electrically insulating material, deposited at the outer periphery of said first cover layer by atomic layer deposition, with the understanding that this sequence of at least one first cover layer and at least one second cover layer can be repeated z times, where z≥1, and that the last layer of the encapsulation system deposited is a so-called second cover layer (3) made of an electrically insulating material deposited by atomic layer deposition;

at least one anode contact member, capable of making the electrical contact between said unit cell and an external conductive element, said battery comprising a contact surface defining at least one anode connection zone; and

and at least one cathode contact member capable of making the electrical contact with an external conductive element, said battery comprising a contact surface defining at least one cathode connection zone,

said battery being characterised in that each of the anode and cathode contact members comprises: a first electrical connection layer, disposed on at least the anode connection zone and at least the cathode connection zone, this first layer comprising a material filled with electrically conductive particles, preferably a polymeric resin and/or a material obtained by a sol-gel method, filled with electrically conductive particles and more preferably a graphite-filled polymeric resin, and a second electrical connection layer comprising a metal foil disposed on the first layer of material filled with electrically conductive particles.

The invention includes a metal foil in the second electrical connection layer thereof. As understood within the scope of the invention, such a metal foil advantageously has a “free-standing” structure. In other words, it is produced “ex situ”, then brought into the vicinity of the first layer above. This metal foil can be obtained, for example, by rolling; in this case, the rolled foil can have undergone a final soft annealing, either partially or completely.

The metal foil, used in the invention, can also be obtained by other methods, in particular by electrochemical deposition or electroplating. In such a case, it can typically be carried out “ex situ” as described hereinabove. Alternatively, it can also be carried out “in situ”, i.e. directly on the first layer above.

In any case, once produced, this metal foil has a controlled thickness.

It should be noted that the layer comprising copper metal obtained from a nanoparticle-filled ink, which is described in International Patent Publication No. WO 2019/215410 mentioned hereinabove, is in no way a metal foil as understood within the scope of the invention. More specifically, the layer disclosed in this prior art document does not meet any of the above criteria.

Typically, the thickness of this metal foil is comprised between 5 and 200 micrometres. Moreover, this metal foil is advantageously perfectly dense and electrically conductive. By way of non-limiting examples, this metal foil can be made from the following materials: nickel, stainless steel, copper, molybdenum, tungsten, vanadium, tantalum, titanium, aluminium, chromium and the alloys comprising them.

The use of such a metal foil gives significant advantages compared to the solutions of the prior art described hereinabove.

In essence, the metal foil firstly procures a significantly improved imperviousness compared to the deposition of metal nanoparticles. More specifically, the films obtained by sintering contain more point defects, making them less hermetically sealed.

Moreover, the surfaces of the metal nanoparticles are often covered with a thin oxide layer, the nature whereof limits the electrical conductivity thereof. Conversely, the use of a metal foil improves airtightness and electrical conductivity.

Furthermore, the use of a metal foil allows a wide range of materials to be used. This ensures that the chemical composition in contact with the anodes and cathodes respectively is electrochemically stable. Conversely, in the prior art, the choice of available materials for forming nanoparticles is relatively limited.

Finally, the invention enables the life of the battery to be extended, in particular by reducing the air permeation coefficient (water vapour transmission rate, WVTR) at the contact members. Such a coefficient will be defined in more detail in the description hereinbelow.

According to other features of the battery according to the invention, which may be taken in isolation or according to any technically compatible feature:

the metal foil is of the free-standing type, said metal foil being advantageously applied to said first electrical connection layer,

the metal foil is produced by rolling or electroplating,

the thickness of the metal foil is comprised between 5 and 200 micrometres, this metal foil in particular being made from one of the following materials: nickel, stainless steel, copper, molybdenum, tungsten, vanadium, tantalum, titanium, aluminium, chromium and the alloys comprising them,

each of the anode and cathode contact members comprises a third electrical connection layer comprising a conductive ink disposed on the second electrical connection layer,

the battery further comprises:

an electrical connection support, made at least in part of a conductive material, which support is provided near an end face of a unit cell,

electrical insulation means, enabling two distant regions of this connection support to be insulated from one another, these distant regions forming respective electrical connection paths,

said anode contact member enabling a first lateral face of each unit cell to be electrically connected to a first electrical connection path, whereas said cathode contact member enables a second lateral face of each unit cell to be electrically connected to a second electrical connection path,

the electrical connection support is of the single-layer type, in particular a metal grid or a silicon interlayer,

the electrical connection support is of the multilayer type and comprises a plurality of layers disposed one below the other, this support being in particular of the printed circuit board type, and

said battery is a lithium-ion battery.

The invention also relates to a method of manufacturing a battery, said battery comprising:

at least one unit cell, said unit cell successively comprising an anode current-collecting substrate, an anode layer, a layer of an electrolyte material or of a separator impregnated with an electrolyte, a cathode layer, and a cathode current-collecting substrate,

an encapsulation system covering at least part of the outer periphery of at least the unit cell,

at least one anode contact member, capable of making the electrical contact between at least the unit cell and an external conductive element, said battery comprising a contact surface defining at least one anode connection zone, and

at least one cathode contact member capable of making the electrical contact with an external conductive element, said battery comprising a contact surface defining at least one cathode connection zone,

said manufacturing method comprising:

a) supplying at least one anode current-collecting substrate foil coated with an anode layer, and optionally coated with a layer of an electrolyte material or a separator impregnated with an electrolyte, hereinafter referred to as an anode foil,

b) supplying at least one cathode current-collecting substrate foil coated with a cathode layer, and optionally coated with a layer of an electrolyte material or a separator impregnated with an electrolyte, hereinafter referred to as a cathode foil, with the understanding that at least one of the anode foil and cathode foil is coated with a layer of an electrolyte material or a separator impregnated with an electrolyte,

c) producing a stack (I) alternating at least one anode foil and at least one cathode foil to successively obtain at least one anode current-collecting substrate, at least one anode layer, at least one layer of an electrolyte material or of a separator impregnated with an electrolyte, at least one cathode layer, and at least one cathode current-collecting substrate,

d) heat treating and/or mechanically compressing the stack of alternating foils obtained in step c), so as to form a consolidated stack,

e) carrying out a step of encapsulating said consolidated stack, by depositing:

at least one first cover layer, preferably chosen from among parylene, parylene F, polyimide, epoxy resins, acrylates, fluoropolymers, silicone, polyamide, sol-gel silica, organic silica and/or a mixture thereof, on the battery, then

at least one second cover layer made of an electrically insulating material, deposited at the outer periphery of at least the first cover layer by atomic layer deposition, with the understanding that the sequence of at least one first cover layer and at least one second cover layer can be repeated z times, where z≥1, and that the last layer of the encapsulation system deposited is a so-called second cover layer made of an electrically insulating material deposited by atomic layer deposition,

f) making two cuts (Dn, D′n) so as to form a cut stack exposing at least the anode and cathode connection zones,

g) producing anode and cathode contact members comprising:

depositing, on at least the anode connection zone and at least the cathode connection zone, preferably on at least the contact surface, a first electrical connection layer made of a material filled with electrically conductive particles, said first layer preferably being made of polymeric resin and/or a material obtained by a sol-gel method filled with electrically conductive particles,

optionally, when said first layer is made of polymeric resin and/or a material obtained by a sol-gel method filled with electrically conductive particles, a drying step followed by a step of polymerising said polymeric resin and/or said material obtained by a sol-gel method,

depositing, on the first layer, a second electrical connection layer comprising a metal foil disposed on the first electrical connection layer, advantageously by applying said metal foil to said first layer.

According to other features of the process according to the invention, which may be taken in isolation or according to any technically compatible feature:

the metal foil is formed by rolling, and then this metal foil thus formed is applied to the first electrical connection layer,

the metal foil is formed directly by electroplating, either ex situ or in situ with respect to the first metal connection layer,

the method comprises, after step g), on at least the anode and cathode connection zones of the battery, coated with the first and second electrical connection layer, a step h) of depositing a conductive ink,

said electrically insulating material is selected from Al₂O₃, SiO₂, SiO_{y}Nₓ, and epoxy resins,

the second cover layer comprises parylene N,

the thickness of the first cover layer is comprised between 1 μm and 50 μm, preferably equal to about 10 μm, and the thickness of the second cover layer is less than 200 nm, preferably comprised between 5 nm and 200 nm, and more preferably equal to about 50 nm,

the impervious sealing means are coated after the electrical connection support has been placed near the first end face of the unit stack,

at least part of the impervious sealing means is coated before the electrical connection support is placed near the first end face of the unit stack,

at least one first layer of the impervious sealing means is coated before the electrical connection support is placed near the first end face of the unit stack, then at least one second layer of the impervious sealing means is coated after said electrical connection support has been placed near said first end face,

the method further comprises:

supplying a frame (105) intended to form a plurality of supports (5),

placing said frame near the first end face of a plurality of unit stacks, these stacks being arranged in a plurality of lines and/or rows, and

making at least one cut, in particular a plurality of cuts in the longitudinal direction and/or lateral direction of these stacks, so as to form a plurality of electrochemical devices.

Finally, the invention has as object, an electric energy-consuming device comprising a body and an above battery, said battery being capable of supplying electric energy to said electric energy-consuming device, and in which the electric connection support (5) of said battery being fastened to said body.

### DRAWINGS

The accompanying figures diagrammatically show multi-layer batteries encapsulated according to different embodiments of the invention. They correspond to cross-sections perpendicular to the thickness of the layers.

FIG. 1 shows a battery comprising an encapsulation system according to the invention which is formed by two superimposed layers.

FIG. 2 shows a battery comprising a similar encapsulation system which has two successions of two layers.

FIGS. 3 and 4 are perspective views showing stacks alternating anode and cathode foils, included in two alternative embodiments of a method for manufacturing a battery according to the invention.

FIG. 5 is a longitudinal, sectional view showing the battery in FIG. 1, further including a conductive support.

FIG. 6 is a longitudinal, sectional view showing an alternative embodiment to that shown in FIG. 5.

FIG. 7 is an overhead view showing a frame allowing for the simultaneous production of a plurality of batteries according to FIG. 5 or 6.

FIG. 8 is a front view, similar to that of FIG. 5, showing a step of producing the battery shown in FIG. 5.

FIG. 9 is an overhead view showing cuts made in the frame in FIG. 7, in order to obtain a plurality of batteries.

FIG. 10 is a front view showing the integration of the battery in FIG. 5 into an energy-consuming device.

FIG. 11 is a front view, similar to that of FIG. 10, showing an alternative embodiment to that shown in FIG. 10, in particular with regard to the structure of the conductive support.

FIG. 12 is a perspective, exploded view of the different components of the conductive support in FIG. 11.

### DESCRIPTION

The present invention applies to a so-called unit electrochemical cell, i.e. a stack 1 successively comprising an anode current collector, an anode layer, a layer of an electrolyte material or a separator impregnated with an electrolyte, a cathode layer and a cathode current collector. Said collector is also referred to herein as a “collecting substrate”, i.e. an anode collecting substrate and a cathode collecting substrate. The present invention further applies to a battery including a stack of a plurality of unit cells.

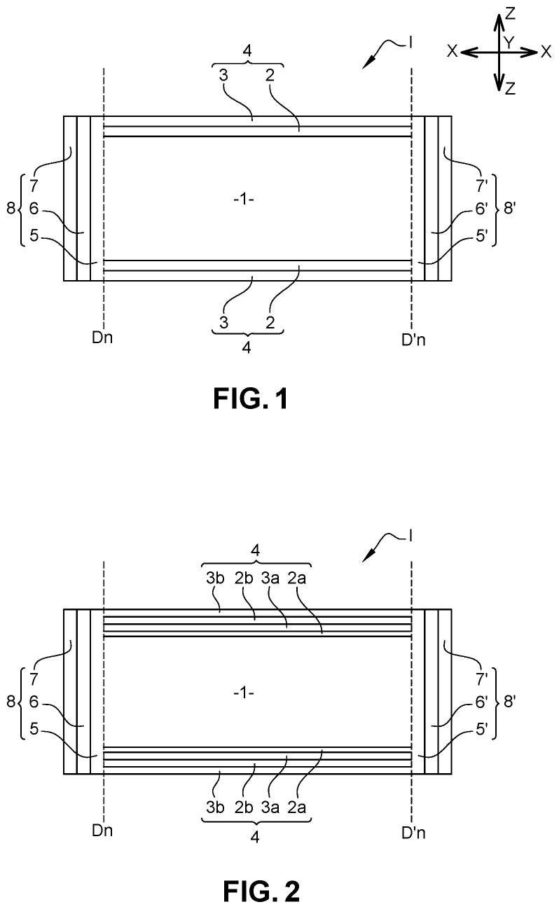

In FIGS. 1 and 2, the orthogonal coordinate system XYZ has been used, wherein the axis XX is a first horizontal axis, i.e. it is included in the plane of the different layers making up the stack. Moreover, this axis XX is referred to as transverse, i.e. it extends laterally with reference to the foil. In particular, it is perpendicular to the plane of the contact members, which will be described hereinbelow.

The axis YY is a second horizontal axis, also included in the plane of the layers of the stack. This axis YY is referred to as sagittal, i.e. it extends from the back to the front of the foil. In particular, it is parallel to the plane of the contact members.

Finally, the axis ZZ extends vertically, while being perpendicular to each of the above axes. It is also referred to as the frontal axis.

The encapsulation representing one key feature of the invention is described here with reference to FIGS. 1 and 2. The battery is denoted as a whole by the reference I. The reference numeral 10 denotes, as a whole, a sectional view of the battery I showing the alternating “open” layers that form the stack 1 of the battery. Conventionally, this stack is, for example, a “mille-feuille” made up of a succession of anode collector/anode/electrolyte or impregnated separator/cathode/cathode collector layers.

After producing the stack of the anode and cathode layers, which make up the battery, and after the mechanical and/or heat treatment step for consolidating the stack (this treatment can be a thermocompression treatment, comprising the simultaneous application of a high pressure and a high temperature), this stack is encapsulated by depositing an encapsulation system 4 to protect the battery cell from the atmosphere. The encapsulation system must be chemically stable, able to withstand a high temperature and impermeable to the atmosphere to fulfil its function as a barrier layer.

The stack 1 can be covered with an encapsulation system 4 comprising: a first dense and insulating cover layer 2, preferably selected from parylene, parylene F, polyimide, epoxy resins, acrylates, fluoropolymers, silicone, polyamide, sol-gel silica, organic silica and/or a mixture thereof, deposited on the stack of notched anode and notched cathode foils; and a second cover layer 3 consisting of an electrically insulating material, deposited by atomic layer deposition on the stack of anode and cathode foils or on said first cover layer.

This sequence can be repeated z times, where z≥1. It has a barrier effect, which increases as the value of z increases. It is important that the last layer of the encapsulation system is a cover layer made of an electrically insulating material so that the encapsulation system is completely impervious.

As it can thus be seen in FIG. 1, the encapsulation system 4 is formed by a simple sequence of a first cover layer 2 and a second cover layer 3, whereas in FIG. 1, a first sequence 2a, 3a formed by a first cover layer 2a and by a second cover layer 3a is superimposed, followed by a second sequence 2b, 3b of the same type.

Typically, the first cover layer 2 is selected from the group consisting of: silicones (for example deposited by impregnation or by plasma-enhanced chemical vapour deposition from hexamethyldisiloxane (HMDSO)), epoxy resins, polyimide, polyamide, poly-para-xylylene (also called poly(p-xylylene), but better known as parylene), and/or a mixture thereof. This first cover layer protects the sensitive elements of the battery from the environment thereof. The thickness of said first cover layer is preferably comprised between 0.5 μm and 3 μm.

This first cover layer is especially useful when the electrolyte and electrode layers of the battery have porosities: it acts as a planarisation layer, which also has a barrier effect. By way of example, this first layer is capable of lining the surface of the microporosities opening out onto the surface of the layer, to close off the access thereto.

In this first cover layer 2, different parylene variants can be used. Parylene C, parylene D, parylene N (CAS 1633-22-3), parylene F or a mixture of parylene C, D, N and/or F can be used. Parylene is a dielectric, transparent, semi-crystalline material with high thermodynamic stability, excellent resistance to solvents and very low permeability. Parylene also has barrier properties. Parylene F is preferred within the scope of the present invention.

This first cover layer 2 is advantageously obtained from the condensation of gaseous monomers deposited by chemical vapour deposition (CVD) on the surfaces of the stack of the battery, which results in a conformal, thin and uniform covering of all of the accessible surfaces of the stack. This first cover layer is advantageously stiff; it cannot be considered to be a flexible surface.

The second cover layer 3 is formed by an electrically insulating material, preferably an inorganic material. It is advantageously deposited by atomic layer deposition (ALD), by PECVD, by HDPCVD (high density plasma chemical vapour deposition) or by ICP CVD (inductively coupled plasma chemical vapour deposition) in order to obtain a conformal covering of all of the accessible surfaces of the stack previously covered with the first cover layer. The layers deposited by ALD are mechanically very fragile and require a stiff bearing surface to fulfil their protective role. The deposition of a fragile layer on a flexible surface would result in the formation of cracks, causing this protective layer to lose integrity. Furthermore, the growth of the layer deposited by ALD is influenced by the nature of the substrate. A layer deposited by ALD on a substrate having zones of different chemical natures will have inhomogeneous growth, which can cause this protective layer to lose integrity. For this reason, this second layer ideally bears against said first layer, which ensures a chemically homogeneous growth substrate.

ALD deposition techniques are particularly well suited for covering surfaces with a high roughness in a completely impervious and conformal manner. They allow for the production of conformal layers, free of defects such as holes (so-called “pinhole-free” layers) and represent very good barriers. The WVTR thereof is extremely low. The WVTR (water vapour transmission rate) is used to evaluate the water vapour permeance of the encapsulation system. The lower the WVTR, the more impervious the encapsulation system. The thickness of this second layer is advantageously chosen as a function of the desired level of imperviousness to gases, i.e. the desired WVTR, and depends on the deposition technique used, chosen in particular from among ALD, PECVD, HDPCVD and ICPCVD. Advantageously, this second layer preferably has a water vapour permeance (WVTR) of less than 10-5 g/m2.d. The water vapour permeance (WVTR) can be measured using a method that is the object of the U.S. Pat. No. 7,624,621 and that is also described in the publication “Structural properties of ultraviolet cured polysilazane gas barrier layers on polymer substrates” by A. Mortier et al. published in Thin Solid Films 6+550 (2014) 85-89.

Said second cover layer 3 can be made of a ceramic material, vitreous material or glass-ceramic material, for example in the form of an oxide, of the Al2O3 or Ta2O5 type, a nitride, a phosphate, an oxynitride or a siloxane. This second cover layer preferably has a thickness comprised between 10 nm and 50 nm.

This second cover layer 3 deposited by ALD, PECVD, HDPCVD (high density plasma chemical vapour deposition) or ICP CVD (inductively coupled plasma chemical vapour deposition) on the first cover layer firstly makes it possible to render the structure impervious, i.e. to prevent water from migrating inside the object, and secondly makes it possible to protect the first cover layer, which is preferably made of parylene F, from the atmosphere, in particular from air and moisture, and from thermal exposure in order to prevent the degradation thereof. This second cover layer thus improves the life of the encapsulated battery.

The outer layer of the multi-layer sequence of a dense and insulating first cover layer, preferably selected from parylene, parylene F, polyimide, epoxy resins, acrylates, fluoropolymers, silicone, polyamide and/or a mixture thereof, can be deposited on the stack of notched anode and notched cathode foils, and of a second cover layer made of an electrically insulating material, deposited by atomic layer deposition on said first cover layer, must be a cover layer made of an electrically insulating material deposited by atomic layer deposition in order to prevent short-circuits at the interface between the contact members and the encapsulation system.

The stack thus coated is covered on the six faces thereof with the encapsulation material. It is then cut by any suitable means along the D′n and Dn cutting lines, so as to expose the anode and cathode connection zones and obtain unit batteries. These lines are shown in FIGS. 1 and 2. As a result of this exposure, only four faces of the stack are now covered by respective regions of the encapsulation system. More specifically, frontal encapsulation regions 40, 41 firstly cover the opposing end faces 10 and 11 of the stack, whereas sagittal encapsulation regions cover the opposing sagittal faces 12 and 13 of this stack. In the figures, the sagittal region before encapsulation has been shown by the dotted line reference 42.

Contact members (electrical contacts) 8 and 8′ are added where the cathode and respectively anode connection zones are apparent, i.e. at the lateral faces 14 and 15 of the stack. These contact zones are preferably disposed on opposite sides of the stack of the battery to collect the current (lateral current collectors). The contact members are disposed at least on the cathode connection zone and at least on the anode connection zone, preferably on the face of the coated and cut stack comprising at least the cathode connection zone and on the face of the coated and cut stack comprising at least the anode connection zone.

Preferably, the contact members are constituted, in the vicinity of the cathode and anode connection zones, by a stack of layers successively comprising a first electrical connection layer 5, 5′ comprising a material filled with electrically conductive particles, preferably a polymeric resin and/or a material obtained by a sol-gel method, filled with electrically conductive particles and more preferably a graphite-filled polymeric resin, and a second layer consisting of a metal foil disposed on the first layer.

The first electrical connection layer 5, 5′ allows the subsequent second electrical connection layer 6, 6′ to be fastened while providing “flexibility” at the connection without breaking the electrical contact when the electric circuit is subjected to thermal and/or vibratory stresses.

The second electrical connection layer 6, 6′ is a metal foil. This second electrical connection layer is used to provide the batteries with lasting protection against moisture. In general, for a given thickness of material, metals make it possible to produce highly impervious films, more impervious than ceramic-based films and even more impervious than polymer-based films, which are generally not very impervious to the passage of water molecules. It increases the calendar life of the battery by reducing the WVTR at the contact members.

Typically, each first layer 5, 5′ is fastened respectively to the anode or cathode terminations by adhesive bonding. With this in mind, a conductive adhesive layer can be used. In particular, two layers of conductive adhesives can be used, the properties whereof are different from one another. These layers are “successive”, i.e. the first layer covers the terminations, whereas the second layer covers this first layer. Advantageously, these two conductive adhesives can have different physical-chemical properties, in particular different wettabilities.

Moreover, the metal foil 6, 6′ is fastened onto the first layer 5, 5′ also by adhesive bonding, more precisely by means of a conductive adhesive which must, advantageously, be electrochemically stable when in contact with the electrodes. This metal foil, bonded using a conductive adhesive, improves the imperviousness of the terminations and reduces the electrical resistance thereof. This technical effect is noteworthy, regardless of the method for manufacturing this foil.

Advantageously, a third electrical connection layer 7, 7′ comprising a conductive ink can be deposited on the second electrical connection layer 6, 6′; the purpose thereof is to reduce the WVTR, thus increasing the life of the battery.

The contact members allow the electrical connections to be made alternating between positive and negative at each of the ends. These contact members enable parallel electrical connections to be made between the different battery elements. For this purpose, only the cathode connections protrude at one end, and the anode connections are available at another end.

It should be noted that the batteries in FIGS. 1 and 2 must comply with the conditions regarding imperviousness, which is a key criterion of the invention. For this purpose, the contact members 8 and 8′ are made of a conductive material that meets this imperviousness criterion. Such a material is, for example, a conductive glass, in particular of the type filled with a metal powder (for example filled with particles (and preferably nanoparticles) of chromium, aluminium, copper and other metals that are electrochemically stable at the electrode's operating potential).

Advantageously, as is known per se, a plurality of unit stacks, such as that described hereinabove, can be produced simultaneously. This increases the efficiency of the overall method for manufacturing the batteries according to the invention. In particular, a stack having large dimensions can be produced, formed by an alternating succession of cathode and respectively anode strata, or foils.

The physical-chemical structure of each anode or cathode foil, which is of a type known, for example, in the French patent document FR 3 091 036 filed by the applicant, does not fall within the scope of the invention and will be described only briefly. Each anode or respectively cathode foil comprises an anode active layer or respectively a cathode active layer. Each of these active layers can be solid, i.e. they can have a dense or porous nature. Furthermore, in order to prevent electrical contact between two adjacent foils, a layer of electrolyte or a separator impregnated with a liquid electrolyte is disposed on at least one of these two foils, in contact with the opposite foil. The electrolyte layer or the separator impregnated with a liquid electrolyte, not shown in the figures describing the present invention, is sandwiched between two foils of opposite polarity, i.e. between the anode foil and the cathode foil.

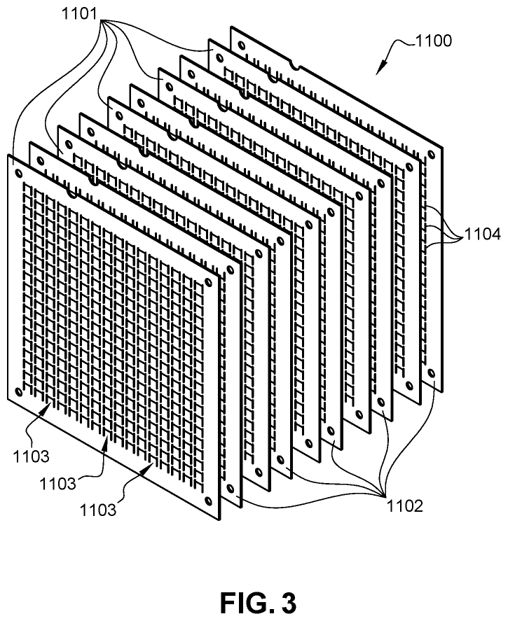

These strata are indented so as to define so-called empty zones which will allow for the separation between the different final batteries. Within the scope of the present invention, different shapes can be assigned to these empty zones. As already proposed by the Applicant in the French patent document FR 3 091 036, these empty zones can be H-shaped. The accompanying FIG. 3 shows the stack 1100 between anode foils or strata 1101 and cathode foils or strata 1102. As shown in this figure, cuts are made in these different foils to create said H-shaped anode 1103 and respectively cathode 1104 empty zones.

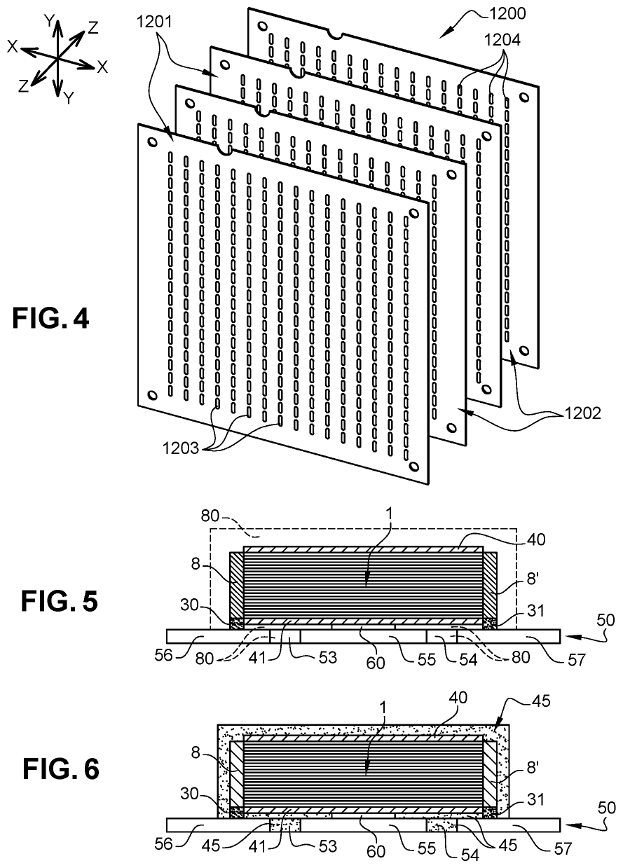

Alternatively, these free zones can also be I-shaped. The accompanying FIG. 4 shows the stack 1200 between anode foils or strata 1201 and cathode foils or strata 1202. As shown in FIG. 4, cuts are made in these different foils to create said I-shaped anode 1203 and respectively cathode 1204 empty zones.

Preferably, once the manufacture of the different unit stacks is complete, each anode and each cathode of a given battery comprises a respective primary body, separated from a respective secondary body by a space free of any electrode material, electrolyte and/or current-conducting substrate. According to an additional alternative embodiment, not shown, the empty zones can be provided such that the shapes thereof are different to a H or an I shape, such as a U shape. Nonetheless, H or I shapes are preferred. Said empty zones can be filled with a resin during the manufacturing method.

FIG. 5 and the following figures show additional advantageous alternative embodiments, wherein the above battery further includes a support. These figures diagrammatically show the stack 1, the frontal encapsulation regions 40 and 41, and the contact members 8 and 8′. The aforementioned support 50, which is generally planar, typically has a thickness of less than 300 μm, preferably less than 100 μm. This support is advantageously made of an electrically conductive material, typically a metal material, in particular aluminium, copper, or stainless steel, which can be coated to improve the weldability property thereof by a thin layer of gold, nickel and tin. The so-called front face of the support is respectively given the reference numeral 51 and faces the unit stack, and the opposite, rear face is given the reference numeral 52.

This support is perforated, i.e. it has spaces 53 and 54 delimiting a central base plate 55 and two opposite lateral strips 56 and 57. The different regions 55, 56 and 57 of this support are thus electrically insulated from one another. In particular, as will be seen hereafter, the lateral strips 56 and 57 form regions which are electrically insulated from one another and which can be connected to contact members belonging to the battery. In the example shown, electrical insulation is achieved by providing empty spaces 53 and 54 which, as will be seen hereafter, are filled with a stiffening material. Alternatively, these spaces can be filled with a non-conductive material, for example polymers, ceramics, or glasses.

In the example shown, the support and the stack are connected to one another by a layer 60. The latter is typically formed by means of a non-conductive adhesive, in particular of the epoxy or acrylate type. Alternatively, the support and the stack can be rigidly secured to one another by means of a weld, not shown. The thickness of this layer 60 is typically comprised between 5 μm and 100 μm, in particular equal to about 50 μm. According to the main plane of the support 50, this layer at least partially covers the aforementioned spaces 53 and 54, so as to insulate the anode and cathode contact members from one another as described in detail hereinbelow. Moreover, pads 30 and 31 of a conductive adhesive allow the contact members to be fastened to the support 5, while ensuring electrical continuity.

According to a first possibility, corresponding to the embodiment shown in FIG. 5, the material forming the contact members 8 and 8′ is capable of fulfilling an impervious sealing function according to the above criterion. For this purpose, this material typically belongs to the list presented hereinabove with reference to the description of the first three figures. In such a case, there is no need to provide an additional encapsulation. More specifically, thanks to the presence of the impervious contact members and encapsulation, the unit stack of anodes and cathodes is protected against the penetration of potentially detrimental gases.

According to a second possibility, corresponding to the embodiment shown in FIG. 6, the material forming the contact members 8 and 8′ is not impervious as understood within the scope of the invention. In such a case, the battery advantageously comprises an additional so-called encapsulation layer 45, shown in solid lines in FIG. 6. This additional layer provides the stack with the desired imperviousness, such that it is “re-encapsulated.” Advantageously, this encapsulation layer 45 has a water vapour permeance (WVTR coefficient or WVTR) of less than 10⁻⁵ g/m².d, as defined above.

In order to guarantee the key criterion regarding imperviousness, this encapsulation layer 45 firstly covers the contact members 8 and 8′. Moreover, it extends into the intermediate space made between the initial encapsulation layer 41 and the opposite face of the support 50. Finally, it also extends into the free spaces 53 and 54 in the support. In the bottom part of this FIG. 6, the reference numeral 45 has been given three more times to these specific zones. As a result, components that are detrimental to the proper functioning of the battery cannot access the unit stack of the anodes and cathodes. In other words, the invention prevents any potential “gateway” for these detrimental components.

According to a third possibility, not shown, only the unit stack is firstly placed on the support, with the interposition of the non-conductive adhesive layer. The lateral faces of the stack are then covered with the contact members. With this in mind, the unit stack, already provided with these contract members yet without its encapsulation system, can also be placed on the support thereof. Finally, the encapsulation system is deposited, while taking care to ensure total imperviousness, as described hereinabove.

Finally, according to one advantageous embodiment of the invention, the battery can be further equipped with a stiffening system. This can firstly be applied to the battery as shown in FIG. 5, which has impervious contact members. This stiffening system is thus denoted as a whole by the reference numeral 80. In such a case, the stiffening material covers the top face of the battery, as well as the lateral contact members. This stiffening material also advantageously fills the intermediate space between the layer 41 and the support 50, as well as the free spaces 53, 54 in the support. In order to show this filling, the reference numeral 80 has been used several times in the different zones occupied by the stiffening material.

In a manner not shown, the stiffening material can also be applied to the battery in FIG. 6, which has contact members that are not impervious. In such a case, the stiffening material covers the additional encapsulation system 45 at the top and lateral edges thereof. It should be noted that this stiffening material can be intimately bonded to the encapsulation material 45, in the free spaces 53, 54, as well as in the intermediate space between the layer 41 and the support 50.

This stiffening system 80 can be made of any material that provides this mechanical stiffness function. With this in mind, a resin can be chosen for example, which can consist of a simple polymer or a polymer filled with inorganic fillers. The polymer matrix can be from the family of epoxies, acrylates or fluorinated polymers for example, and the fillers can be formed by particles, flakes or glass fibres.

Advantageously, this stiffening system 80 can provide an additional moisture barrier function. With this in mind, a low melting point glass can be chosen, for example, thus ensuring the mechanical strength and providing an additional moisture barrier. This glass can be, for example, from the SiO₂—B₂O₃; Bi₂O₃—B₂O₃, ZnO—Bi₂O₃—B₂O₃, TeO₂—V₂O₅ or PbO—SiO₂ family.

Typically, the stiffening system 80 is much thicker than the encapsulation system. With reference to FIG. 5 the smallest thickness of this stiffening system, at the covering of the front face of the stack, is denoted by the reference E80. Advantageously, this thickness E80 is comprised between 20 and 250 μm, typically equal to about 100 μm. The presence of an additional stiffening system brings additional advantages. This stiffening system thus provides a mechanical and chemical protection function, optionally combined with an additional gas barrier function.

The integration of the battery according to the invention onto the support 50, as described hereinabove, can be achieved by individually placing each unit stack on the support thereof. Nonetheless, a plurality of batteries are advantageously manufactured simultaneously, each integrating such a support.

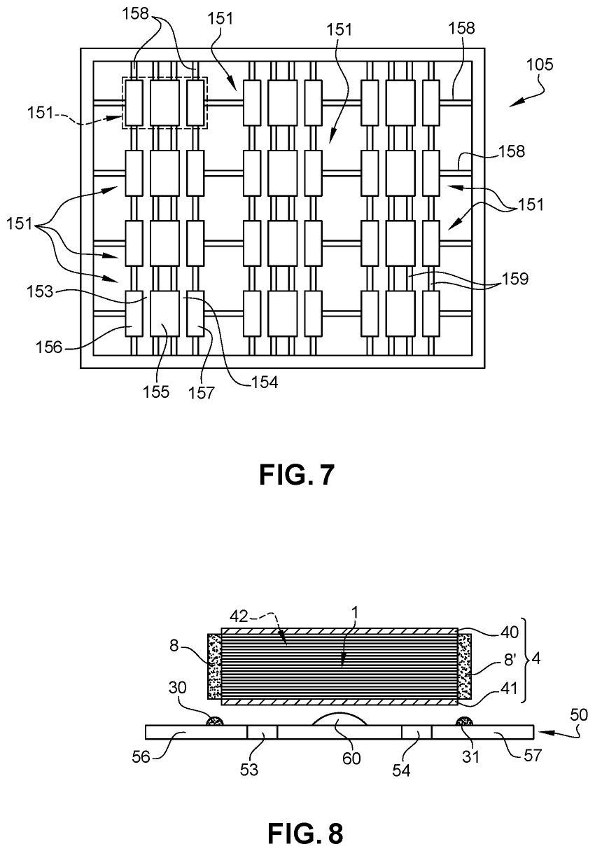

With this in mind, such a simultaneous manufacturing method is shown in FIGS. 7 to 9. In order to implement this method, a support frame 105 is advantageously used, and which is intended to form a plurality of supports 50. This frame 104, which is shown at a large scale in FIG. 7, has a peripheral border 150, as well as a plurality of preforms 151, each of which allows one respective battery to be manufactured. In the example shown, twelve mutually identical preforms can be seen, divided into three lines and four columns. Alternatively, a frame with a different number of such preforms can be used.

Each preform comprises a central area 155, intended to form the base plate 55, and two lateral blocks 156 and 157 intended to form the strips 56 and 57 respectively. The area and the blocks are separated from one another by grooves 153 and 154, which are intended to form the spaces 53 and 54. The different preforms are fixed, both in relation to one another and to the peripheral edge by means of different horizontal rods 158 and vertical rods 159 respectively.

In this embodiment, each preform 151 receives an already encapsulated battery, which is thus in accordance with that shown in FIG. 1. In terms of manufacturing methods, a dose 106 of non-conductive adhesive is deposited on each area 155 to form the layer 6, and doses 130 and 131 of conductive adhesive are deposited to form the pads 30 and 31. The encapsulated stack is then placed in contact with the support so as to form the adhesive layer 60 and the pads 30 and 31, allowing this stack to be mutually fastened to the support.

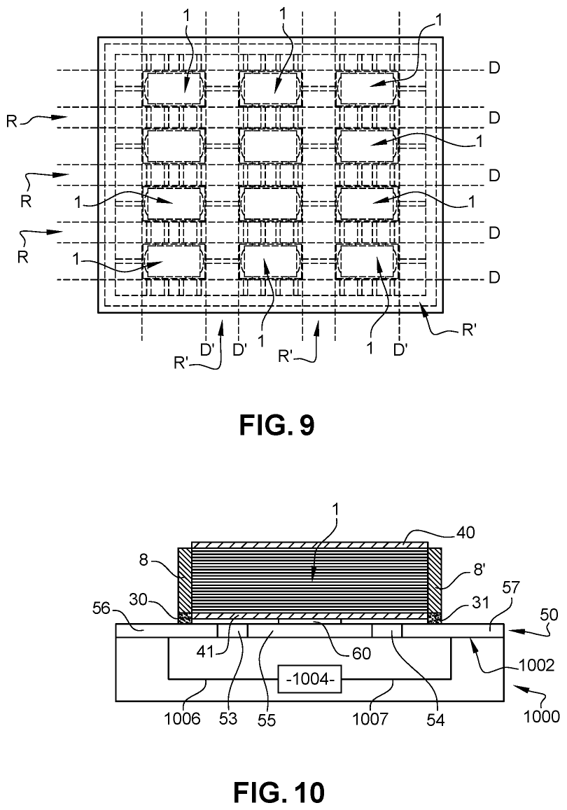

Finally, as shown in FIG. 9, a cut is made in the frame 150, on which the different components of the plurality of batteries have been disposed. The different cutting lines are marked with dotted lines and given the reference D for cuts in the longitudinal dimension of the batteries and the reference D′ for cuts in the lateral dimension thereof. It should be noted that, in the two dimensions of the frame, certain zones R and R′ are intended to be discarded.

According to an alternative embodiment, not shown, the electrochemical device according to the invention can include one or more additional electronic components. Such a component can, for example, be of the LDO (“low dropout regulator”) type. Typically, production of a mini-circuit with a complex electronic function can be envisaged. With this in mind, an RTC (“real time clock”) module or an energy harvesting module can be used. In this embodiment, the one or more electronic components are advantageously covered by the same encapsulation system as that protecting the unit stack.

In operation, in a conventional manner, electrical energy is stored at the unit stack. This energy is transmitted to the conductive regions 55 and 56 of the support 50 via the contact members and via the conductive adhesive pads 30 and 31. Since these conductive regions are insulated from one another, there is no risk of a short-circuit. This electrical energy is then directed from the regions 56 and 57 to an energy-consuming device of any appropriate type.

In FIG. 10, this energy-consuming device is represented diagrammatically and is denoted by the reference numeral 1000. It comprises a body 1002, on which the lower face of the support rests. The mutual fastening between this body 1002 and the support 50 is achieved by any appropriate means. It should be noted that, in FIG. 10, the device 1000 integrates the battery shown in FIG. 5, the contact members whereof are impervious. According to an alternative embodiment, not shown, the battery in FIG. 6 can also be combined with the energy-consuming device 1000. In such a case, as explained hereinabove, it must be ensured that the additional encapsulation material 45 makes the unit stack of the anodes and cathodes perfectly impervious. Reference is made in this respect to the description given hereinabove, in particular with regard to the different locations of the reference numeral 45 in FIG. 6.

The device 1000 further comprises an energy-consuming element 1004, as well as connection lines 1006, 1007 electrically connecting the regions 56, 57 of the support 50 to this element 1004. Control thereof can be provided by a component of the battery itself, and/or by a component, not shown, belonging to the device 1000. By way of non-limiting examples, such an energy-consuming device can be an electronic circuit of the amplifier type, an electronic circuit of the clock type (such as a real time clock (RTC) component), an electronic circuit of the volatile memory type, an electronic circuit of the static random access memory (SRAM) type, an electronic circuit of the microprocessor type, an electronic circuit of the watchdog timer type, a component of the liquid crystal display type, a component of the LED (light emitting diode) type, an electronic circuit of the voltage regulator type (such as a low-dropout regulator circuit (LDO)), or an electronic component of the CPU (central processing unit) type.

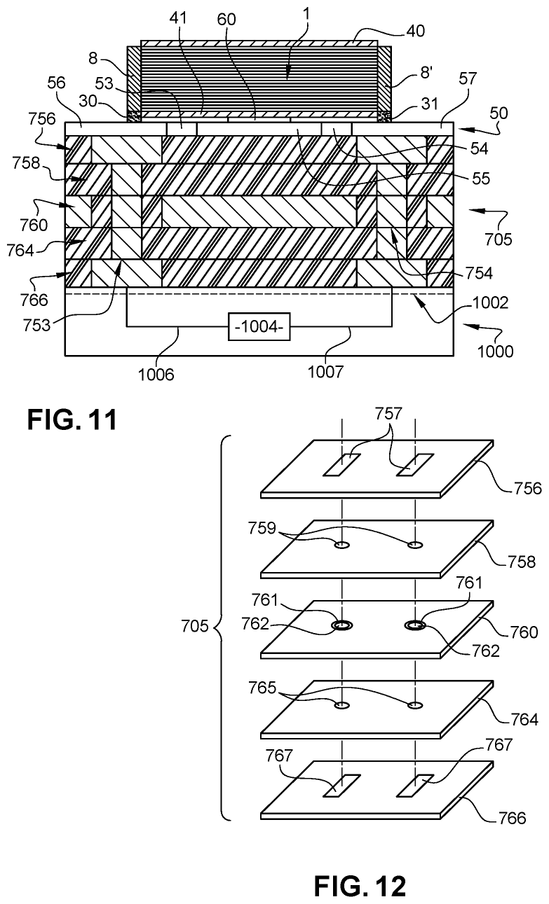

An alternative embodiment will now be described with reference to FIGS. 11 and 12, wherein the conductive support 750 is of the multi-layer type, as opposed to the aforementioned support 50, which is of the single-layer type. Furthermore, this support 750 is of the solid type, as opposed in particular to the metal grid hereinabove which is of the perforated type. As shown in FIG. 11, the support 750 is formed by layers, for example made of a polymer material. These layers extend one below the other, the main plane thereof being substantially parallel to the plane of the layers forming the stack 1 described hereinabove. The structure of this support is thus similar to that of a printed circuit board (PCB).

FIGS. 11 and 12 show, from top to bottom, a layer 756 on which the stack of the battery will be deposited. This layer 756, which is mainly made of a polymer material, such as epoxy resin, is provided with two inserts 757. These are made of a conductive material, in particular a metal material, and are designed to cooperate with the anode and respectively the cathode contacts of the battery. It should be noted that these inserts 757 are insulated from one another, thanks to the epoxy resin of the layer 756.

Immediately below the layer 756 is a layer 758, also made of a polymer material such as an epoxy resin. This layer 758 is provided with 2 inserts 759, made of a conductive material, which are brought into electrical contact with the first inserts 757. As with the layer 756, these inserts 759 are insulated from one another.

A median layer 760 is then present, which is significantly different from the layers 756 and 758 described hereinabove. More specifically, this layer 760 is made of a conductive material, typically similar to that forming the inserts 757 and 759 described hereinabove. This layer is equipped with two ring-shaped inserts 761, which are made of an insulating material, in particular an epoxy resin as described hereinabove. These inserts 761 receive, in the hollow central part thereof, discs 762 made of a conductive material, which are placed in contact with the adjacent conductive inserts 759. It should be noted that these conductive discs 762 are insulated from one another via the rings 761.

Finally, bottom layers 764 and 766 in FIGS. 11 and 12 are present, which are respectively identical to the layers 758 and 756 described hereinabove. The layer 764 is equipped with 2 inserts 765, in contact with the discs 762, whereas the bottom layer 766 is provided with 2 inserts 767, in contact with the aforementioned inserts 765. The different conductive inserts 757, 759, 762, 765 and 767 define conductive paths denoted by the reference numerals 753, 754, which electrically connect the opposing end faces of the support 705. These paths are insulated from one another, either by the layers 756, 758, 764 and 766 or by the discs 761.

In this embodiment, the stiffening system can be different from that 80 of the first embodiment. A protective film 780 can in particular be deposited by means of a lamination step. Such a film, which has barrier properties, is for example made of polyethylene terephthalate (PET) incorporating inorganic multi-layers; such a product that may be suitable for this application, is commercially available from the company 3M under the reference Ultra Barrier Film 510 or Ultra Barrier Solar Films 510-F. Such a stiffening system, using films obtained by rolling, can however be used in other applications, in addition to those shown in FIG. 11.

FIG. 11 further shows the integration, on an energy-consuming device 1000, of the support 705, the stack 702, the conductive pads 730 and 740, the encapsulation 707 and the film 708. As with the first embodiment, the energy generated at the stack 702 is transmitted, via the contact members 730 and 740, to the upper inserts 757. This energy is then transmitted along the connection paths 753, 754 described hereinabove, to the energy-consuming device 1000.

In the most general structure thereof, the multi-layer support can be formed of only two separate layers, one below the other. These layers define conductive paths, similar to the conductive paths 753, 754 described hereinabove. There are specific advantages to this particular embodiment shown with reference to FIG. 11. More specifically, the multi-layer support such as that denoted by the reference numeral 750 has a very small thickness, advantageously less than 100 μm. Moreover, such a support has a certain flexibility, so that it can accommodate slight changes in the dimensions of the battery, referred to as “breaths” in the introduction to this description. This support further benefits from a particularly satisfactory bending strength, with a view to the integration thereof on a flexible electronic circuit.

The invention is not limited to the examples described and illustrated.

According to a first alternative embodiment, not shown, each current-collecting substrate can be perforated, i.e. it can have at least one through-opening. Advantageously, the transverse dimension of each perforation (or opening) is comprised between 0.02 mm and 1 mm. Moreover, the void fraction of each perforated substrate is comprised between 10% and 30%. This means that, for a given surface area of this substrate, between 10% and 30% of this surface area is occupied by the perforations.

The technical purpose of these perforations or openings is as follows: the first layer deposited on one of the two faces of the substrate will bond, inside the openings, against the first layer deposited on the other of the two faces of the substrate. This improves the quality of the deposits, in particular the adhesion of the layers in contact with the substrate. More specifically, during the drying and sintering operations, the aforementioned layers undergo slight shrinkage, i.e. a slight decrease in the longitudinal and lateral dimensions thereof, whereas the dimensions of the substrate are substantially unvarying. This tends to create shear stresses at the interface between the substrate and each layer, thus reducing the quality of the adhesion; this stress increases as the thickness of the layers increases.

Under these conditions, providing a perforated substrate significantly improves the quality of this adhesion. In essence, the layers situated on opposite faces of this substrate tend to weld to one another inside the different perforations. This allows the deposition thickness of the layers to be increased, even though they no longer contain organic binders after annealing. This alternative embodiment also allows the battery power to be increased. It is particularly well suited to use with ultra high-power electrodes of the thick mesoporous type.

The method according to the invention is particularly adapted to the manufacture of solid-state batteries, i.e. batteries whose electrodes and electrolyte are solid and do not comprise a liquid phase, even impregnated in the solid phase.

The method according to the invention is also particularly adapted to the manufacture of batteries considered to be quasi-solid-state comprising at least one separator impregnated with an electrolyte.

Said separator is preferably a porous inorganic layer having: a porosity, preferably mesoporous, that is greater than 30%, preferably comprised between 35% and 50%, and more preferably between 40% and 50%, and pores with an average diameter D50 of less than 50 nm.

The separator is often understood to be sandwiched between the electrodes. In the present example embodiment, this is a ceramic or glass ceramic filter deposited on at least one of the electrodes and sintered to produce a solid assembly of the batteries. The fact that a liquid is nano-confined inside this separator gives the final battery quasi-solid properties.

The thickness of the separator is advantageously less than 10 μm, preferably comprised between 3 μm and 16 μm, more preferably between 3 μm and 6 μm, even more preferably between 2.5 μm and 4.5 μm, so as to reduce the final thickness of the battery without weakening the properties thereof. The pores of the separator are impregnated with an electrolyte, preferably with a lithium-ion carrying phase such as liquid electrolytes or an ionic liquid containing lithium salts. The “nano-confined” or “nano-entrapped” liquid in the porosities, and in particular in the mesoporosities, can no longer escape. It is bound by a phenomenon referred to herein as “absorption in the mesoporous structure” (which does not seem to have been described in the literature within the context of lithium-ion batteries) and it can no longer escape, even when the cell is placed in a vacuum. Such a battery is thus considered to be a quasi-solid-state battery.

The method according to the invention, and the encapsulation system, can in particular be applied to any type of thin-film battery, in particular to any type of lithium-ion battery.

These lithium-ion batteries can be solid-state, multi-layer, lithium-ion batteries, quasi-solid-state, multi-layer, lithium-ion batteries and can in particular be solid-state, multi-layer, lithium ion microbatteries. More generally, these lithium-ion batteries can in particular use anode layers, electrolyte layers and cathode layers such as those described in the international patent document WO 2013/064777 within the scope of a microbattery, i.e. anode layers made from one or more of the materials described in claim 13 of this document, cathode layers made from one or more of the materials described in claim 14 of this document, and electrolyte layers made from one or more of the materials described in claim 15 of this document.

The battery according to the invention can be a lithium-ion microbattery, a lithium-ion mini-battery, or a high-power lithium-ion battery. In particular, it can be designed and dimensioned to have a capacity of less than or equal to about 1 mA h (commonly known as a “microbattery”), to have a power of greater than about 1 mA h up to about 1 A h (commonly known as a “mini-battery”), or to have a capacity of greater than about 1 A h (commonly known as a “high-power battery”). Typically, microbatteries are designed to be compatible with methods for manufacturing microelectronics.

The batteries of each of these three power ranges can be produced: with layers of the “solid-state” type, i.e. without impregnated liquid or paste phases (said liquid or paste phases can be a lithium-ion conductive medium, capable of acting as an electrolyte), or with layers of the mesoporous “solid-state” type, impregnated with a liquid or paste phase, typically a lithium-ion conductive medium, which spontaneously penetrates the layer and no longer emerges therefrom, so that the layer can be considered to be quasi-solid, or with impregnated porous layers (i.e. layers with a network of open pores which can be impregnated with a liquid or paste phase, which gives these layers wet properties).

### Example

An example embodiment of a battery according to the invention is given below.

Manufacturing a battery using encapsulations and electrical contact members according to the invention
Production of a Li4Ti5O12-based anode:

Li₄Ti₅O₁₂ nanoparticles were prepared for use as an anode material by grinding to a particle size of less than 100 nm. The Li₄Ti₅O₁₂ nanoparticles were then dispersed in 10 g/l of absolute ethanol with a few ppm of citric acid to obtain a suspension of Li₄Ti₅O₁₂ nanoparticles.

The negative electrodes were prepared by electrophoretic deposition of the Li₄Ti₅O₁₂ nanoparticles contained in the previously prepared suspension, on stainless steel strips. The Li₄Ti₅O₁₂ film (approx. 1 μm) was deposited on both faces of the substrate. These films were then heat treated at 600° C. for 1 hour to weld the nanoparticles together, improve adhesion to the substrate and perfect the recrystallisation of the Li₄Ti₅O₁₂.
Production of a Li₁₊ₓMn_{2-y}O₄-based cathode:

Crystalline Li₁₊ₓMn_{2-y}O₄ nanoparticles were prepared as a cathode material, where x=y=0.05, by grinding to particle sizes of less than 100 nm. The Li₁₊ₓMn_{2-y}O₄ nanoparticles were then dispersed in 25 g/l of absolute ethanol to obtain a suspension of Li₁₊ₓMn_{2-y}O₄ nanoparticles. This suspension was then diluted in acetone to a concentration of 5 WI.

The positive electrodes were prepared by electrophoretic deposition of the Li₁₊ₓMn_{2-y}O₄ nanoparticles contained in the previously prepared suspension, where x=y=0.05, on stainless steel strips. The Li₁₊ₓMn_{2-y}O₄ thin film (approx. 1 μm) was deposited on both faces of the substrate. These films were then heat treated at 600° C. for 1 hour to weld the nanoparticles together, improve adhesion to the substrate and perfect the recrystallisation of the Li₁₊ₓMn_{2-y}O₄.
Production, on the anode and cathode layers previously created, of a mesoporous layer from a suspension of Li₃PO₄:

A suspension of Li₃PO₄ nanoparticles was prepared from the two solutions presented hereinbelow.

45.76 g of CH₃COOLi, 2H₂O was dissolved in 448 ml of water, then 224 ml of ethanol was added under vigorous stirring in the medium to obtain solution A. 16.24 g of H₃PO₄ (85 wt % in water) was diluted in 422.4 ml of water, then 182.4 ml of ethanol was added to this solution to obtain a second solution, hereafter referred to as solution B.

Solution B was then added, under vacuum stirring, to solution A. The solution obtained, which is perfectly clear after the disappearance of the bubbles formed during mixing, was added to 4.8 litres of acetone under the action of a homogeniser of the Ultraturrax™ type in order to homogenise the medium. A white precipitation suspended in the liquid phase was immediately observed.

The reaction medium was homogenised for 5 minutes and then held for 10 minutes under magnetic stirring. It was left to decant for 1 to 2 hours. The supernatant was discarded and the remaining suspension was centrifuged for 10 minutes at 6000 g. 1.2 l of water was then added to place the precipitate back in suspension (using a sonotrode and magnetic stirring). Two additional washes of this type were then carried out with ethanol. Under vigorous stirring, 15 ml of a 1 g/ml solution of Bis(2-(methacryloyloxy)ethyl)phosphate was added to the resulting colloidal suspension in ethanol. The suspension has thus become more stable. The suspension was then subjected to ultrasonic vibrations using a sonotrode. The suspension was then centrifuged for 10 minutes at 6000 g. The pellet was then re-dispersed in 1.2 l of ethanol and centrifuged for 10 minutes at 6000 g. The pellets thus obtained were re-dispersed in 900 ml of ethanol to obtain a 15 g/l suspension suitable for electrophoretic deposition.

Agglomerates of about 200 nm consisting of primary Li₃PO₄ particles measuring 10 nm were thus obtained in suspension in the ethanol.

Porous thin layers of Li₃PO₄ were then deposited by electrophoresis on the surface of the previously prepared anodes and cathodes by applying an electric field of 20 V/cm to the previously obtained suspension of Li₃PO₄ nanoparticles for 90 seconds to obtain a layer of about 2 μm. The layer was then air-dried at 120° C., and then a calcination treatment was carried out at 350° C. for 120 minutes on this previously dried layer in order to remove all traces of organic residues.

A plurality of thin-film anodes and respectively cathodes were produced according to the method described hereinabove.
Construction of a battery comprising a plurality of electrochemical cells:

A plurality of thin-film anodes and respectively cathodes were produced according to the examples described hereinabove. These electrodes were covered with an electron separator layer from a suspension of Li₃PO₄ nanoparticles as shown hereinabove:

After depositing 2 μm of porous Li₃PO₄ on each of the previously created electrodes (Li₁₊ₓMn_{2-y}O₄ and Li₄Ti₅O₁₂), the two sub-systems were stacked such that the Li₃PO₄ films were in contact with one another. This stack comprising an alternating succession of cathodes and anodes in thin layers covered with a porous layer and whose Li₃PO₄ films were in contact, was then hot-pressed in a vacuum.

For this purpose, the stack was placed under a pressure of 5 MPa and then dried in a vacuum for 30 minutes at 10⁻³ bar. The press platens were then heated to 550° C. at a speed of 0.4° C./second. At 550° C., the stack was then thermo-compressed under a pressure of 45 MPa for 20 minutes, then the system was cooled to ambient temperature. Once the assembly was completed and dried at 120° C. for 48 hours in a vacuum (10 mbar), a stiff, multi-layer system consisting of a plurality of assembled cells was obtained.
Production of an electrochemical cell or of an encapsulated battery:

An electrochemical cell, or respectively a battery comprising a plurality of electrochemical cells, was produced according to the preceding example. These devices are encapsulated by successive layers.

A first layer of parylene F (CAS 1785-64-4) approximately 2 μm thick was deposited by CVD on the electrochemical cell, respectively on the battery comprising a plurality of electrochemical cells.

A layer of alumina Al₂O₃ was then deposited by ALD on this first layer of parylene F. The electrochemical cell, respectively the battery comprising a plurality of electrochemical cells coated with a parylene layer was inserted into the chamber of a Picosun™ P300 ALD reactor. The ALD reactor chamber was previously placed under a vacuum at 5 hPa and 120° C. and previously subjected, for 30 minutes, to a flow of trimethylaluminium (hereafter referred to as TMA, CAS No. CAS: 75-24-1), a chemical precursor of alumina under a nitrogen atmosphere containing less than 3 ppm type 1 ultrapure water (σ≈0.05 μS/cm) as a carrier gas at a flow rate of 150 sccm (standard cm³/min), in order to stabilise the reactor chamber atmosphere before any deposition. After stabilisation of the chamber, a 30 nm layer of Al₂O₃ was deposited by ALD.

A layer of parylene F approximately 2 μm thick was then deposited by CVD on the second layer of alumina Al₂O₃.

A layer of alumina Al₂O₃ approximately 30 nm thick was then deposited by ALD, as mentioned hereinabove, on this third layer of parylene F.

It should be noted that, in this example, there is no additional resin above the ALD layer, so as not to create a short-circuit allowing water molecules to pass beneath the interface A.

The stack thus encapsulated was then cut along cutting planes to obtain an electrochemical cell, respectively a unit battery, with the cathode, and respectively anode current collectors of the electrochemical cell, respectively of the battery, being exposed on each of the cutting planes. The encapsulated stack was thus cut on two of the six faces of the stack so as to make the cathode and respectively the anode current collectors apparent.

This assembly was then impregnated, in an anhydrous atmosphere, by dipping in an electrolytic solution containing PYR14TFSI and 0.7 M LiTFSI. PYR14TFSI is the common abbreviation for 1-butyl-1-methylpyrrolidinium bis(trifluoromethanesulfonyl)imide. LITFSI is the common abbreviation for lithium bis(trifluoromethane)sulphonimide (CAS No.: 90076-65-6). The ionic liquid instantly enters the porosities by capillary rise. Each of the two ends of the system was kept immersed for 5 minutes in a drop of the electrolyte mixture.
Production of the contact members of an encapsulated electrochemical cell or of an encapsulated battery:

Contact members were then added where the cathode or respectively the anode current collectors are apparent (not coated with an insulating electrolyte).

A carbon-filled conductive resin of the type Dycotec DM-Cap-4701S is applied to the ends of the encapsulated and cut electrochemical cell, respectively battery. A 5 μm thick 316L type stainless steel foil is applied onto this thin layer of conductive resin. By holding the small stainless steel foil in pressure contact with the end of the battery, the resin is dried at 100° C. for 5 minutes.

A second termination layer is then produced at the two ends of the battery. This second layer covers the stainless steel foils bonded on each of the ends. This second layer is obtained by immersing the ends in a silver-filled conductive adhesive.

The components are then barrel plated in a first bath of nickel sulphamate acidified with boric acid at 60° C. for 25 minutes under a 6 A current. After rinsing, a tin deposit is applied onto the nickel deposit in order to ensure the weldability of the component. This deposition is also carried out using a barrel by electrolytic deposition in a bath of tin metasulphonate and boric acid at pH 4 at 25° C. for 35 minutes.

### LIST OF REFERENCE SYMBOLS

The following references are used in the present description:
I battery
1 unit stack
2 first encapsulation layer
3 second encapsulation layer
4 encapsulation system
5, 5′ first electrical connection layer
6, 6′ second electrical connection layer
7, 7′ third electrical connection layer
8, 8′ contact members
10, 11 end faces of the stack
12, 13 sagittal faces of the stack
14, 15 lateral faces of the stack
30, 31 conductive adhesive pads
40, 41 frontal encapsulation regions
42 sagittal encapsulation region
45 additional encapsulation
50 electrically conductive supports
51, 52 front and rear faces of the support
53, 54 spaces
55 base plate
56, 57 lateral strips
60 layer of non-conductive adhesive
80 stiffening system
105 support frame
106 dose of conductive adhesive
150 border
151 preforms
155 central area
156, 157 lateral blocks
153, 154 grooves
158, 159 rods
130, 131 doses of conductive adhesive
1100, 1200 large stacks
1101, 1201 anode strata
1102, 1202 cathode strata
1103, 1104 H-shaped empty zones
1203, 1204 I-shaped empty zones
1000 energy-consuming device
1002 body
1004 consuming element
1006, 1007 connection lines

1-21. (canceled)

22. A battery, comprising:
at least one unit cell successively comprising an anode current-collecting substrate, an anode layer, a layer of an electrolyte material or a separator impregnated with an electrolyte, a cathode layer, and a cathode current-collecting substrate;
an encapsulation system forming an impervious seal that covers at least part of an outer periphery of said at least one unit cell, the encapsulation system including:
at least one first cover layer deposited on the battery, the at least one first cover layer chosen from a group consisting of parylene, parylene F, polyimide, epoxy resins, acrylates, fluoropolymers, silicone, polyamide, sol-gel silica, organic silica, and/or a mixture thereof, and
at least one second cover layer deposited at the outer periphery of said first cover layer by atomic layer deposition, the at least one second cover layer made of an electrically insulating material, wherein a sequence of the at least one first cover layer and the at least one second cover layer being repeated z times, where z≥1, such that a last cover layer of the encapsulation system deposited is one of the at least one second cover layer,
an anode contact surface defining at least one anode connection zone;
at least one anode contact member to make an electrical contact between said at least one unit cell and an external conductive element at said at least one anode connection zone, the at least one anode contact member including a first anode electrical connection layer and a second anode electrical connection layer, wherein the first anode electrical connection layer comprises a material filled with electrically conductive particles disposed on at least the anode connection zone, and the second anode electrical connection layer comprises a metal foil disposed on the first anode electrical connection layer;
a cathode contact surface defining at least one cathode connection zone; and
at least one cathode contact member to make an electrical contact with an external conductive element at said at least one cathode connection zone, the at least one cathode contact member including a first cathode electrical connection layer and a second cathode electrical connection layer, wherein the first cathode electrical connection layer comprises a material filled with electrically conductive particles disposed on at least the cathode connection zone, and the second cathode electrical connection layer comprises a metal foil disposed on the first cathode electrical connection layer.

23. The battery of claim 22, wherein the metal foil is of a free-standing type.

24. The battery of claim 22, wherein the metal foil is produced by rolling or electroplating.

25. The battery of claim 22, wherein the metal foil:
has a thickness of between 5 and 200 micrometres, and
is composed of one of: nickel, stainless steel, copper, molybdenum, tungsten, vanadium, tantalum, titanium, aluminium, chromium, and alloys thereof.

26. The battery of claim 22, wherein:
the at least one anode contact member further comprises a third anode electrical connection layer comprising a conductive ink disposed on the second anode electrical connection layer, and
the at least one cathode contact member further comprises a third cathode electrical connection layer comprising a conductive ink disposed on the second cathode electrical connection layer.

27. The battery of claim 22, further comprising:
an electrical connection support arranged near an end face of a unit cell in the at least one unit cell, the electrical connection support composed at least in part of a conductive material, the electrical connection support including:
electrical insulation enabling insulation of two distant regions of the electrical connection support from one another, the two distant regions forming respective electrical connection paths in a manner such that said at least one anode contact member enables a first lateral face of each unit cell in the at least one unit cell to be electrically connected to a first electrical connection path, and said at least one cathode contact member enables a second lateral face of each unit cell in the at least one unit cell to be electrically connected to a second electrical connection path.

28. The battery of claim 27, wherein the electrical connection support is a single layer metal grid or a single layer silicon interlayer.

29. The battery of claim 27, wherein the electrical connection support is a multilayer printed circuit board comprising a plurality of layers disposed one below the other.

30. The battery of claim 22, wherein the battery is a lithium-ion battery.

31. A method of manufacturing a battery that includes at least one unit cell, said at least one unit cell successively comprising an anode current-collecting substrate, an anode layer, a layer of an electrolyte material or a separator impregnated with an electrolyte, a cathode layer, and a cathode current-collecting substrate, an encapsulation system covering at least part of an outer periphery of the at least one unit cell, an anode contact surface defining at least one anode connection zone, at least one anode contact member to make an electrical contact between said at least one unit cell and an external conductive element at said at least one anode connection zone, a cathode contact surface defining at least one cathode connection zone; and at least one cathode contact member to make an electrical contact with an external conductive element at said at least one cathode connection zone, the method comprising:
supplying the at least one anode current-collecting substrate coated with the anode layer and a layer of the electrolyte material or a separator impregnated with the electrolyte, to form an anode foil;
supplying the at least one cathode current-collecting substrate coated with the cathode layer and a layer of the electrolyte material or a separator impregnated with the electrolyte to form a cathode foil;
forming a stack alternating at least one anode foil and at least one cathode foil to successively obtain at least one anode current-collecting substrate, at least one anode layer, at least one layer of an electrolyte material or a separator impregnated with an electrolyte, at least one cathode layer, and at least one cathode current-collecting substrate;
heat treating and/or mechanically compressing the stack to form a consolidated unit stack;
encapsulating the consolidated unit stack to form an impervious seal by depositing:
at least one first cover layer chosen from a group consisting of parylene, parylene F, polyimide, epoxy resins, acrylates, fluoropolymers, silicone, polyamide, sol-gel silica, organic silica, and/or a mixture thereof, on the battery, then
via by atomic layer deposition, at least one second cover layer made of an electrically insulating material, deposited at the outer periphery of at least the first cover layer, wherein a sequence of the at least one first cover layer and the at least one second cover layer being repeated z times, where z≥1, such that a last cover layer of the encapsulation system deposited is one of the at least one second cover layer,
making two cuts to form a cut, encapsulated unit stack exposing at least the at least one anode connection zone and the at least one cathode connection zone;
forming the at least one anode contact member and the at least one cathode contact member by:
depositing, on at least the anode connection zone and at least the cathode connection zone, a first electrical connection layer made of a material filled with electrically conductive particles,
depositing the second electrical connection layer on the first electrical connection layer, the second electrical connection layer comprising a metal foil.

32. The method of claim 31, wherein, after forming the at least one anode contact member and the at least one cathode contact member, depositing a conductive ink.

33. The method of claim 31, wherein said electrically insulating material is selected from a group consisting of Al₂O₃, SiO₂, SiO_{y}Nₓ, and epoxy resins.

34. The method of claim 31, wherein the second cover layer comprises parylene N.

35. The method of claim 31, wherein:
the thickness of the first cover layer is equal to about 10 μm, and
the thickness of the second cover layer is equal to about 50 nm.

36. The method of claim 31, further comprising:
arranging an electrical connection support near a first end face of the unit stack, and
coating the impervious seal after arranging the electrical connection support near the first end face of the unit stack.

37. The method of claim 31, further comprising:
coating the impervious seal; and
arranging an electrical connection support near a first end face of the unit stack after coating the impervious seal.

38. The method of claim 31, further comprising:
coating the at least one first layer of the impervious seal;
arranging an electrical connection support near a first end face of the unit stack after coating the least one first layer; and
coating the at least one first layer of the impervious seal after arranging the electrical connection support.

39. The method of claim 31, further comprising:
form a plurality of supports via a frame;
placing said frame near a first end face of a plurality of unit stacks arranged in a plurality of lines and/or rows; and
making a plurality of cuts in a longitudinal direction and/or a lateral direction of the unit stacks to form a plurality of electrochemical devices.

40. An electric energy-consuming device, comprising:
a body;
a battery to supply electric energy to the electric energy-consuming device, the battery including:
at least one unit cell successively comprising an anode current-collecting substrate, an anode layer, a layer of an electrolyte material or a separator impregnated with an electrolyte, a cathode layer, and a cathode current-collecting substrate;
an encapsulation system forming an impervious seal that covers at least part of an outer periphery of said at least one unit cell, the encapsulation system including:
at least one first cover layer deposited on the battery, the at least one first cover layer chosen from a group consisting of parylene, parylene F, polyimide, epoxy resins, acrylates, fluoropolymers, silicone, polyamide, sol-gel silica, organic silica, and/or a mixture thereof, and
at least one second cover layer deposited at the outer periphery of said first cover layer by atomic layer deposition, the at least one second cover layer made of an electrically insulating material, wherein a sequence of the at least one first cover layer and the at least one second cover layer being repeated z times, where z≥1, such that a last cover layer of the encapsulation system deposited is one of the at least one second cover layer,
an anode contact surface defining at least one anode connection zone;
at least one anode contact member to make an electrical contact between said at least one unit cell and an external conductive element at said at least one anode connection zone, the at least one anode contact member including a first anode electrical connection layer and a second anode electrical connection layer, wherein the first anode electrical connection layer comprises a material filled with electrically conductive particles disposed on at least the anode connection zone, and the second anode electrical connection layer comprises a metal foil disposed on the first anode electrical connection layer;
a cathode contact surface defining at least one cathode connection zone;
at least one cathode contact member to make an electrical contact with an external conductive element at said at least one cathode connection zone, the at least one cathode contact member including a first cathode electrical connection layer and a second cathode electrical connection layer, wherein the first cathode electrical connection layer comprises a material filled with electrically conductive particles disposed on at least the cathode connection zone, and the second cathode electrical connection layer comprises a metal foil disposed on the first cathode electrical connection layer; and
an electrical connection support, fastened to said body and arranged near an end face of a unit cell in the at least one unit cell, the electrical connection support composed at least in part of a conductive material.

41. An electric energy-consuming device of claim 40, wherein the electrical connection support comprises:
electrical insulation enabling insulation of two distant regions of the electrical connection support from one another, the two distant regions forming respective electrical connection paths in a manner such that said at least one anode contact member enables a first lateral face of each unit cell in the at least one unit cell to be electrically connected to a first electrical connection path, and said at least one cathode contact member enables a second lateral face of each unit cell in the at least one unit cell to be electrically connected to a second electrical connection path.
